(19) United States
(12) Patent Application Publication
(10) Pub. No.: US 2025/0076244 A1
(43) Pub. Date: Mar. 6, 2025

(54) Detection in Electrochemical Sensors

(71) Applicant: Cirrus Logic International Semiconductor Ltd., Edinburgh (GB)

(72) Inventor: John P. LESSO, Edinburgh (GB)

(73) Assignee: Cirrus Logic International Semiconductor Ltd., Edinburgh (GB)

(21) Appl. No.: 18/813,175

(22) Filed: Aug. 23, 2024

Related U.S. Application Data
(60) Provisional application No. 63/536,106, filed on Sep. 1, 2023.

(51) Int. Cl. G01N 27/327; G01N 27/404

(52) U.S. Cl. CPC G01N 27/3273; G01N 27/3272; G01N 27/404

(57) ABSTRACT

Circuitry for detecting application of an electrochemical sensor to a subject, the electrochemical sensor comprising an ion-selective electrode and a first potentiostatic electrode, the circuitry comprising: measurement circuitry configured to: measure a ion-selective signal at the ion-selective electrode; measure a potentiostatic signal at the first potentiostatic electrode; processing circuitry configured to: detect application of the electrochemical sensor to the subject based on the ion-selective signal and the potentiostatic signal.

### TECHNICAL FIELD

The present disclosure relates to circuitry and methods for detecting application of electrochemical sensors to subjects.

### BACKGROUND

Electrochemical sensors are widely used for the detection or characterisation of one or more chemical species, analytes, typically as an oxidation or reduction current. Such sensors comprise an electrochemical cell, consisting of two or more electrodes configured for contact with an analyte whose concentration is to be ascertained.

For potentiostatic measurement typically used for characterisation of potentiostatic cells, sensors may comprise circuitry for driving one or more of the electrodes and circuitry for measuring a response signal at one or more of the electrodes. The measured response signal can be processed to determine a concentration of an analyte. Potentiostatic sensors typically employ enzymatic sensing to characterize analyte concentration.

For potentiometric measurement typically used for characterisation of ion-selective electrode (ISE) sensors, a potential difference is measured between two electrodes having an analyte between them with no external bias and with no current flow. A working electrode (indicator electrode) reacts with the analyte and the reference electrode provides a voltage to complete the cell. Thus, the potential difference between the working electrode and the reference electrode gives an indication of a property of the electrodes and the analyte.

When electrochemical sensors integrated into wearable devices for analyte monitoring, it is advantageous for the device to know when such electrochemical sensors have been attached or inserted onto or into a user. One known way to detect insertion is to use magnets, which add to complexity and cost of a wearable devices.

### SUMMARY

According to an aspect of the disclosure, there is provided circuitry for detecting application of an electrochemical sensor to a subject, the electrochemical sensor comprising an ion-selective electrode and a first potentiostatic electrode, the circuitry comprising: measurement circuitry configured to: measure an ion-selective signal at the ion-selective electrode; measure a potentiostatic signal at the first potentiostatic electrode; processing circuitry configured to: detect application of the electrochemical sensor to the subject based on the ion-selective signal and the potentiostatic signal.

The ion-selective signal may comprise a voltage.

The potentiostatic signal may comprise a current.

Detecting application of the electrochemical sensor to the body may comprise: calculating a first score based on the ion-selective signal, the first score indicative of a proximity of the ion-selective signal to an expected ion-selective signal when the electrochemical sensor is applied to the body; calculating a second score based on the potentiostatic signal, the second score indicative of a proximity of the potentiostatic signal to an expected potentiostatic signal when the electrochemical sensor is applied to the body; and determining whether the electrochemical sensor is applied to the body based on the first and second scores.

Determining whether the electrochemical sensor is applied to the body based on the first and second scores may comprise: comparing the first score to a first score threshold; comparing the second score to a second score threshold; and determining that the electrochemical sensor is applied to the body if the first and second scores exceed respective first and second thresholds.

The processing circuitry may be configured to: calculate the first score by comparing the ion-selective signal to a first distribution centred on the expected ion-selective signal; and calculate the second score by comparing the potentiostatic signal to a second distribution centred on the expected ion-selective signal.

Determining whether the electrochemical sensor is applied to the subject based on the first and second scores may comprise: combining the first and second scores to obtain a combined score; and comparing the combined score a combined score threshold; and determining that the electrochemical sensor is applied to the subject if the combined score exceed the combined score threshold.

The first and second scores may be weighted prior to the combining.

The first and second scores may be weighted to maximise a false accept rate (FAR) and minimize a false reject rate (FRR) associated detecting application of the electrochemical sensor.

The combined score SF may be calculated by the following equation:

$${S}_{F} = α {S}_{1} + ( 1 - α {S}_{2} )$$

Where S₁ is the first score, S₂ is the second score, and a is a weighting factor between zero and one.

The measurement circuitry may comprise a transimpedance amplifier or a current conveyor for measuring the potentiostatic signal.

The measurement circuitry may comprise an analog-to-digital converter, ADC, configured to sample the potentiostatic signal.

The circuitry may further comprise drive circuitry configured to apply a stimulus to a second potentiostatic electrode of the electrochemical sensor, the measured potentiostatic signal being a response to the stimulus.

The drive circuitry may comprise a digital to analog converter, DAC.

The electrochemical sensor may comprise a second potentiometric electrode, wherein the processing circuitry may be configured to determine an impedance between the first and second potentiostatic electrodes. The first potentiometric electrode may comprise a working electrode and the second potentiometric electrode may comprise a counter electrode.

The processing circuitry may be configured to transition the wearable sensor from a low-power state to an active state upon detection of application of the wearable sensor to the subject.

The processing circuitry may be configured to: determine a concentration of an analyte in the electrochemical sensor based on the ion-selective electrode signal. The analyte may be sodium or potassium or magnesium.

The processing circuitry may be configured to determine a concentration of an analyte in the electrochemical sensor based on the potentiostatic signal. The analyte may be glucose or ketones or lactates.

Application of the electrochemical sensor to the subject may comprise insertion of the ion-selective electrode and the first potentiostatic electrode through the skin of the subject. Alternatively, application may comprise locating the electrochemical cell in or proximate an analyte of interest.

According to another aspect of the disclosure, there is provided an electrochemical sensor comprising: a needle for insertion into a subject on application of the electrochemical sensor to the subject; an ion-selective electrode; a first potentiostatic electrode; and circuitry as described above, wherein the ion-selective electrode and the potentiostatic electrode are disposed on the needle.

According to another aspect of the disclosure, there is provided a system comprising: the wearable device; and a host device comprising the circuitry as described above.

According to another aspect of the disclosure, there is provided an integrated circuit, comprising circuitry as described above.

According to another aspect of the disclosure, there is provided an electronic device, comprising circuitry as described above.

The electronic device may comprise one of one of a wearable device, an analyte monitoring device, an analyte sensing device, a battery, a battery monitoring device, a mobile computing device, a laptop computer, a tablet computer, a games console, a remote-control device, a home automation controller or a domestic appliance, a toy, a robot, an audio player, a video player, or a mobile telephone, and a smartphone.

According to another aspect of the disclosure, there is provided a method of detecting application of an electrochemical sensor to a subject, the electrochemical sensor comprising an ion-selective electrode and a first potentiostat electrode, the method comprising: measuring an ion-selective signal at the ion-selective electrode; measuring a potentiostatic signal at the first potentiostatic electrode; detecting application of the electrochemical sensor to the subject based on the ion-selective signal and the potentiostatic signal.

Throughout this specification the word “comprises”, or variations such as “comprises” or “comprising”, will be understood to imply the inclusion of a stated element, integer or step, or group of elements, integers or steps, but not the exclusion of any other element, integer or step, or group of elements, integers or steps.

### BRIEF DESCRIPTION OF DRAWINGS

Embodiments of the present disclosure will now be described by way of non-limiting examples with reference to the drawings, in which:

FIG. 1 is a schematic diagram of an electrical equivalent circuit for a three-electrode electrochemical cell;

FIG. 2 is a schematic diagram of an electrical equivalent circuit for a two-electrode electrochemical cell;

FIG. 3 is a schematic diagram of example drive and measurement circuitry for the cell of FIG. 2;

FIG. 4 illustrates a schematic diagram of a potentiometric sensor comprising an ion-selective electrode;

FIG. 5 is a schematic diagram of a known high input impedance measurement circuit;

FIG. 6 is a schematic diagram of an example electrochemical sensor;

FIG. 7 is a schematic diagram of circuitry for detecting application of the electrochemical sensor of FIG. 6 to a body; and

FIG. 8 graphically illustrates example distribution functions for target and non-target impedances for an electrochemical cell.

### DESCRIPTION OF EMBODIMENTS

Embodiments of the present disclosure relate to the detection of application of electrochemical sensors to subjects under test. Application may comprise insertion of one or more electrodes under the skin of a subject (e.g. a human). In particular, embodiments relate to improved methods and circuitry for such detection which utilise signals from two electrodes with different modalities of operation, such as a potentiometric ion-selective electrode (ISE) and a potentiostatic electrode. Signals from each type of electrode can individually indicate an application (e.g. insertion) event. However, by combining signals from two or more electrodes having different modalities of operation, robustness and accuracy of detection of application of a sensor to a subject can be improved, for example by reducing false reject rate (FRR) and false accept rate (FAR).

Whilst embodiments herein are described with reference to a potentiometric electrode (ISE) and a potentiostatic electrode, the present disclosure is not limited to the provision of electrodes of such modalities. The solutions described may apply equally to any combination of electrodes having different modalities. Examples include but are not limited to two ISE electrodes.

FIG. 1 is a schematic diagram of an example electrochemical cell 100 comprising three electrodes, namely a counter electrode CE, a working electrode WE and a reference electrode RE. FIG. 1 also shows an equivalent circuit 102 for the electrochemical cell 100 comprising a counter electrode impedance ZCE, a working electrode impedance ZWE and a reference electrode impedance ZRE.

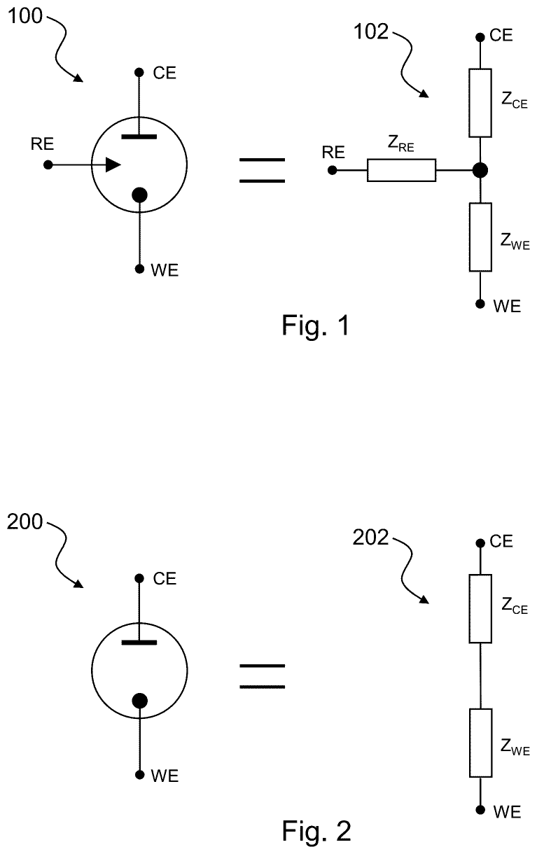

FIG. 2 is a schematic diagram of another example electrochemical cell 200 comprising two electrodes, namely a counter electrode CE and a working electrode WE. The electrochemical cell 200 varies for the cell 100 with the omission of the reference electrode RE. FIG. 2 also shows an equivalent circuit 102 for the electrochemical cell 200 comprising a counter electrode impedance ZCE and a working electrode impedance ZWE.

In some embodiments, the working electrode WE comprise an assay or chemical of interest. For example, for the analysis of glucose as an analyte, the working electrode may comprise a layer of glucose oxidase. The counter electrode CE is provided to form an electrical or ohmic connection with the working electrode WE. Optionally, the reference electrode is provided, which is typically a sensing point between the working electrode WE and the counter electrode CE, allowing independent measurement of the potential associated with each of the working and counter electrodes WE. CE, rather than just measuring a potential difference between the counter and working electrodes CE, WE.

The cells 100, 200 may be implemented for potentiostatic measurement using certain enzymes deposited or coated on respective working electrodes WE. For human health monitoring, example analytes of interest which can be monitored using enzymatic (potentiostatic) sensing include glucose and ketones.

In potentiostatic arrangements, to determine analyte concentration in either of the electrochemical cells 100, 200, it is conventional to apply a bias voltage at the counter electrode CE and measure a current at the working electrode WE. When provided, the reference electrode RE may be used to measure a voltage drop between the working electrode WE and the reference electrode RE. The bias voltage is then adjusted to maintain the voltage drop between the reference and working electrodes RE, WE constant. As the resistance in the cell 100 increases, the current measured at the working electrode WE decreases. Likewise, as the resistance in the cell 100 decreases, the current measured at the working electrode WE increases. Thus, the electrochemical cell 100 reaches a state of equilibrium where the voltage drop between the reference electrode RE and the working electrode WE is maintained constant. Since the bias voltage at the counter electrode CE and the measured current at WE are known, the resistance of the cell 100 can be ascertained.

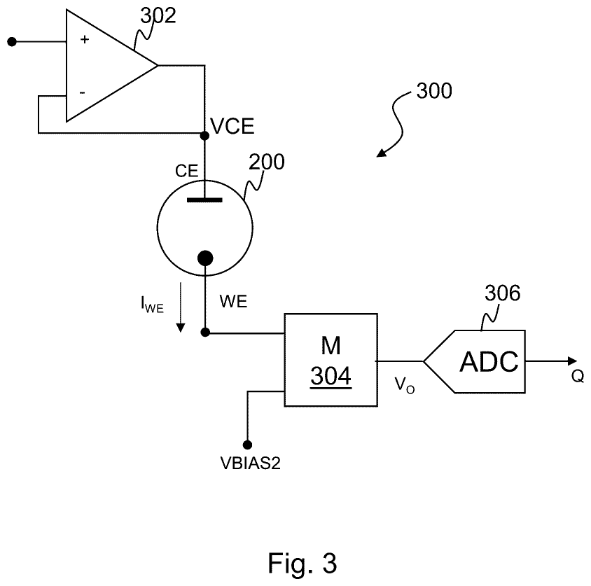

FIG. 3 illustrates an example known drive and measurement circuit 300 which is configured to implement the above explained cell characterisation, specifically for measuring an analyte concentration in the electrochemical cell 200 shown in FIG. 2. The circuit 300 comprises a first amplifier 302 and a measurement circuit 304. Each of the first amplifier 302 and the measurement circuit 304 may comprise one or more op-amps. A non-inverting input of the first amplifier 302 is coupled to a bias voltage VBIAS1 which may be generated by a digital-to-analog converter DAC (not shown). An inverting input of the first amplifier 302 is coupled to the counter electrode CE. An output of the first amplifier 302 is coupled to the counter electrode CE and configured to drive the counter electrode CE with a counter electrode bias voltage VCE. The counter electrode bias voltage VCE applied at the counter electrode CE by the first amplifier 302 is proportional to the difference between the bias voltage VBIAS1 and the voltage at the counter electrode CE.

The measurement circuit 304 is coupled between the working electrode WE and an analog-to-digital converter (ADC) 306. The measurement circuit 304 is operable to output to the ADC 306 a signal proportional to the current flowing from the working electrode WE. The ADC 306 then converts the signal output from the measurement circuit 304 to a digital output signal Q which represents the current flowing from the working electrode WE.

The measurement circuit 304 is typically implemented as a transimpedance amplifier or a current conveyor.

The cells 100, 200 shown in FIGS. 1 and 2 are primarily configured for potentiostatic sensing in which a response of the cells 100, 200 to a stimulus is measured to determine an impedance of the cells 100, 200. An alternative type of sensing is potentiometric sensing, in which a potential across a cell is measured without applying any bias or stimulus to the cell 100.

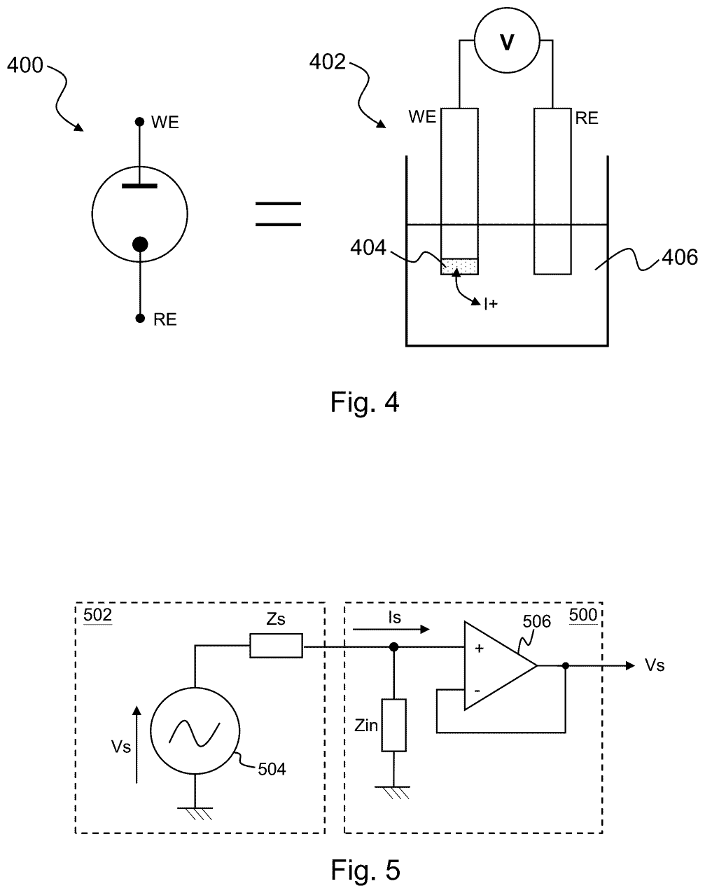

FIG. 4 illustrates an electrochemical cell 400 typically configured for potentiometric sensing alongside a schematic diagram of an example implementation of the electrochemical cell 400 as a potentiometric sensor. The cell 400 comprises a working electrode WE and a reference electrode RE. The working electrode WE comprises an ion-selective membrane 404, which may be configured to uptake only a specific ion (in this case the cation, I+) from an electrolyte solution 406. As such, the potential difference between the working electrode WE and the reference electrode RE depends on the concentration of that particular ion analyte in the electrolyte solution 406. In the health of humans, example ions of interest include potassium, sodium and magnesium.

To accurately measure the potential difference across the cell 400, as little as possible current (ideally no current) need flow into the cell 400. Hence, a typical approach to voltage measurement is to couple each of the working and reference electrodes WE, RE to high input impedance buffers which are used, in turn, to drive one or more ADCs (e.g. two single ended ADCs or one differential ADC). A digital output signal is then derived which represents the potential difference between working and reference electrode WE, RE of the cell 400.

FIG. 5 is a schematic diagram of a typical measurement circuit 500 for measuring a potential difference Vs across the two-electrode cell 400 implemented as a potentiometric sensor. An equivalent circuit model 502 for the cell 400 is shown in FIG. 5. The model comprises a voltage source 504 (generating the potential difference or sense voltage Vs) and a series impedance Zs coupled. The voltage source 504 is coupled between a reference voltage (in this case ground) and the series impedance Zs which itself is coupled to an input of the measurement circuit 500. The measurement circuit 500 comprises a buffer amplifier 506 and an input impedance Zin. A non-inverting input of the buffer amplifier 506 is coupled to the series impedance Zs of the cell 400. The input impedance Zin is coupled between the non-inverting input of the buffer amplifier 506 and a reference voltage (in this case ground). An inverting input and output of the buffer amplifier 506 are coupled together. Thus, the measurement circuit 500 is configured as a high input impedance buffer amplifier which buffers the sense voltage Vs across the cell 400 to the output of the measurement circuit 500.

There is an increasing need in field of wearable medical technology for measurement of multiple analytes of interest. In particular, there is a need to measure analytes such as glucose (using glucose oxidase and potentiostatic sensing) in combination with analytes such as sodium and potassium (using ISEs and potentiometric sensing). It is also advantageous to detect when wearable devices (such as analyte monitoring devices) have been applied to the body of a subject. By providing robust application detection, a device need only turn on when applied to the body of a subject, thereby conserving power and maintaining sensor health.

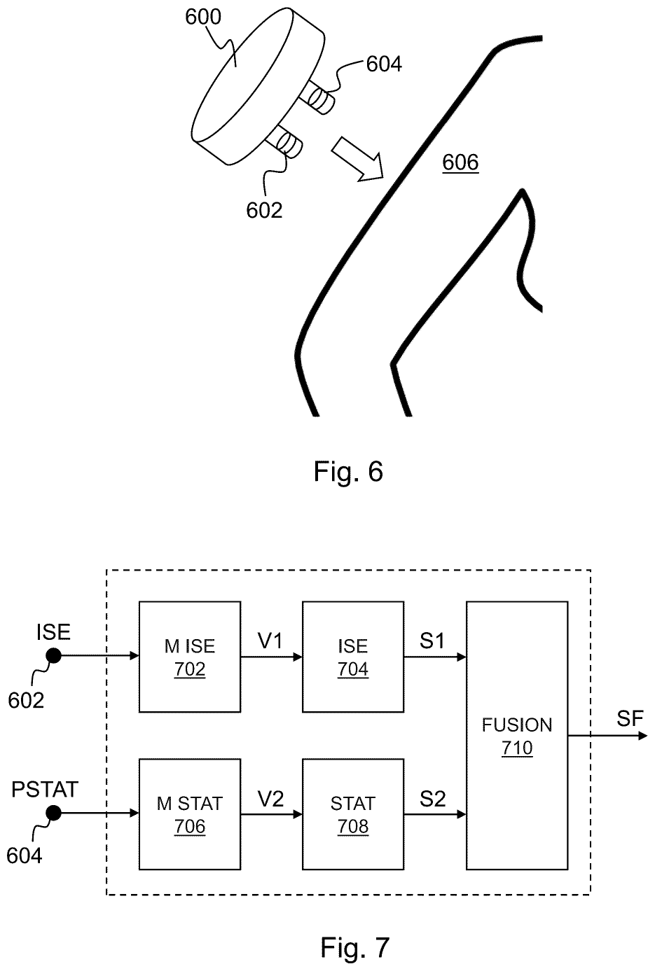

FIG. 6 is a schematic diagram of an example wearable sensor 600 comprising an ion-selective electrode (ISE) 602 and a potentiostatic electrode 604. The potentiostatic electrode 604 may, for example, be a working electrode WE.

The wearable sensor 600 may comprise additional electrodes (not shown). For example, the wearable sensor 600 may comprise a reference electrode to operate in conjunction with the ISE 602. Additionally or alternatively, the sensor 600 may comprise an additional potentiostatic electrode (e.g. counter electrode) to operate in conjunction with the potentiostatic electrode 604. Alternatively, a single additional electrode may be provided to operate in conjunction with the ISE 602 and the potentiostatic electrode 604.

In the arrangement shown, the ISE 602 and potentiostatic electrode 604 are provide on separate needles. In such arrangement, an additional electrode such as those described above may be provided on the same needle as each of the ISE 602 and the potentiostatic electrode 604. In a variation of the arrangement shown in FIG. 6, the ISE 602 and potentiostatic electrode 604 may be provided on the same needle. In which case, additional electrodes may be also be provided on that same needle.

It will also be appreciated that whilst the ISE 602 and potentiostatic electrode 604 are both provided on the single wearable sensor 600, embodiments of the present disclosure are not limited to this fact. In alternative arrangements, the ISE 602 could be provided separately to the potentiometric electrode 604 on separate sensors.

The wearable sensor 600 may further comprise drive and/or measurement circuitry such as but not limited to the circuitry 300, 500 described above with reference to in FIGS. 3 and 5.

The wearable sensor 600 is configured to be applied to the body 606 of a subject, in this case a human. The sensor 600 may be provided as part of host device (not shown), such as an analyte sensing device or continuous glucose monitor.

Embodiments of the present disclosure utilise the presence of multiple electrodes in the same sensor having different measurement characteristics to improve the robustness of detection (e.g. insertion) of an electrochemical sensor on a subject. Specifically, as described above, the ISE 602 is a potentiometric device which generates a voltage only when an ion it is intended to detect is present. Meanwhile, a potentiostatic cell (such as cells 200, 300) comprising the potentiometric electrode 604 has a high impedance until it is applied/inserted, at which point the wetting action due to insertion reduces its impedance.

By monitoring signals from the ISE 602 and the potentiostatic electrode 604, embodiments of the present disclosure may determine whether the sensor 600 has been applied to the body 606, e.g. the electrodes 602, 604 inserted into the body 606.

FIG. 7 is a schematic diagram of example circuitry 700 for processing signals obtained from the ISE 602 and potentiostatic electrode 604. The processing circuitry 700 may be implemented in the wearable sensor 600, a host device, or elsewhere.

The processing circuitry 700 comprises ISE measurement circuitry 702, ISE scoring circuitry 704, potentiostatic measurement circuitry 706, potentiostatic scoring circuitry 708, and fusion circuitry 710. The processing circuitry 700 may be implemented in the analog domain, the digital domain, or a mixture of both analog and digital domains. Conversion between analog and digital domains may be implemented with suitable conversion circuitry (not shown) known in the art.

The ISE measurement circuitry 702 is configured to obtain an ISE signal V1 from the ISE 602. In this example, the ISE signal V1 is in the form of a voltage. For example, the ISE measurement circuitry 702 may comprise the measurement circuitry 500 shown in FIG. 5 or circuitry operating similarly. The ISE signal V1 represents the voltage across the cell comprising the ISE 602. As noted above, when the sensor 600 is not applied to the body 606, the voltage across the cell comprising the ISE 602 should be zero volts. Conversely, when the sensor 600 is applied to the body 606, the voltage across the cell (e.g. cell 400) comprising the ISE 602 will be non-zero, i.e. at some expected voltage.

The potentiostatic measurement circuitry 706 is configured to generate a potentiostatic signal V2 based on a signal at the potentiostatic electrode 604. The signal at the potentiostatic electrode 604 is typically a current. In this example, potentiostatic measurement circuitry 706 is configured to convert that signal to the potentiostatic signal V2 is in the form of a voltage. For example, the potentiostatic measurement circuitry 706 may comprise the measurement circuitry 304 of FIG. 3 (and optionally the ADC 306). As such, the potentiostatic measurement circuitry 706 may be configured to convert a current at the potentiostatic electrode 604 to the potentiostatic signal (voltage) V2. The potentiostatic signal V2 represents the impedance across the cell (e.g. cells 200, 300) comprising the potentiostatic electrode 604. As noted above, when the sensor 600 is not applied to the body 606, the impedance of the cell comprising the potentiostatic electrode 604 will be relatively high (e.g. in the order of 200 megaohms (MOhms), or 1 gigaohms (GOhms)). When the sensor 600 is applied to the body 606, the impedance of the cell comprising the potentiostatic electrode 604 will be relatively low, e.g. in the order of 100 MOhms.

The ISE and potentiostatic score circuitry 704, 708 may be provided as separate circuitry as shown or alternatively may be combined.

Each of the ISE score circuitry 704, and the potentiostatic score circuitry 708 may be configured to determine respective first and second scores S1, S2. The first score S1 may correspond to a likelihood that the sensor 600 is applied to the body 606 based on the ISE signal V1. Likewise, the second score S2 may correspond to a likelihood that the sensor 600 is applied to the body 606 based on the potentiometric signal V2.

One or both of the ISE circuitry 704 and the potentiostatic circuitry 708 may calculate the score using target and non-target distributions. A target distribution may correspond to insertion or application of the sensor 600 to the body 606. A non-target distribution may correspond to the sensor 600 not being inserted in or applied to the body 606. In the examples described below, normal distributions are shown. However, any conceivable distribution may be employed that characterises the sensor 600's behaviour.

For a cell comprising the potentiostatic electrode 604, the delineator is impedance. When the potentiostatic electrode 604 is dry, i.e. no applied to the body 606, the impedance may be relatively high, e.g. approximately 1 GOhm, whereas when the potentiostatic electrode 604 is wet, i.e. applied to the body 606, the impedance may be relatively low, e.g., approximately 100 MOhms.

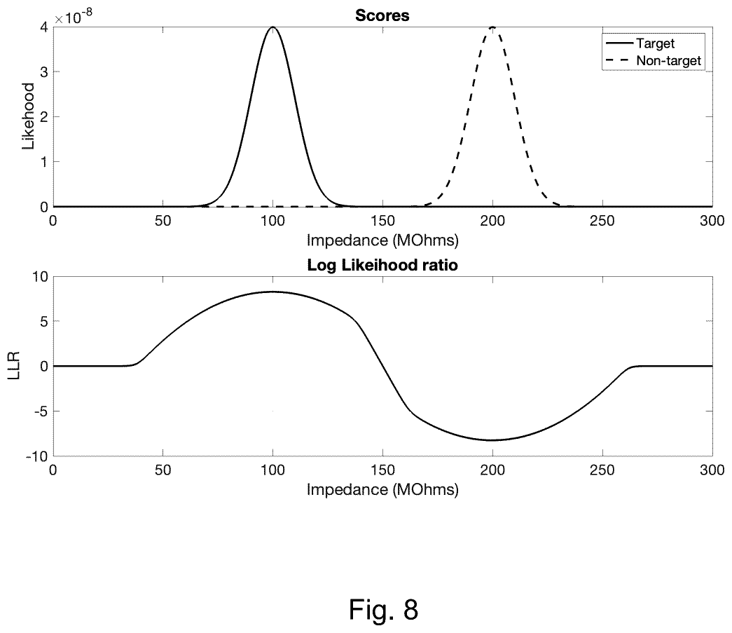

Thus, as shown in FIG. 8, a target range or distribution may be centred on 100 MOhm and a non-target range or distribution may be centred on 1 GOhm. The measured impedance may then be scored against each of the target and non-target distributions. Thus, the second score S2 may be “1” when the impedance of the cell is 100 MOhms (inserted) and “0” when the impedance of the cell is 1 GOhm (not inserted).

A similar approach may be taken to obtain the first score S1, with a target distribution centred around a predetermined voltage, e.g. 50 mV (sensor 600 applied to the body 606) and a non-target distribution centred around zero volts (sensor 600 not applied to the body 606). Thus, a first score S1 may be “1” when the voltage V1 is 50 mV (inserted) and “0” when the voltage is zero volts.

It will be appreciated that alternative solutions may be implemented for determining the first and second scores S1, S2.

Referring again to FIG. 7, the first and second scores S1, S2 are provided to the fusion circuitry 710 which is configured to output a combined or fused score SF based on the first and second scores S1, S2. The fused score SF may represent a likelihood that the sensor 600 is applied and/or not applied to the body 606.

The fusion circuitry 710 may be configured to fuse the first and second scores S1, S2 using any conceivable method.

For example, the fusion circuitry 710 may implement decision-based fusion. For example, when the first score S1 exceeds a first threshold T1, and the second score S2 exceeds a second threshold T2, a determination may be made that the sensor 600 is applied to the body 606. This concept is provided below formulaically:

S₁>T₁

S₂>T₂

The fusion circuitry 710 in this example the fused score may be a binary output, e.g. “1” if both thresholds are met, “0” if either threshold is not met. In this example, false accept rates (FARs) are multiplicative and false reject rates (FRRs) are additive. Thus, the FRR for decision-based fusion is relatively high when compared to score-based fusion described below.

In another example. The fusion circuitry 710 may implement score-based fusion. For example, the first and second scores S1, S2 may be combined by weight, such as using the following formula.

$${S}_{F} = α {S}_{1} + ( 1 - α {S}_{2} )$$

Thus, the fused score SF is calculated based on the first score S1 and the second score S2.

Application of the sensor 600 to the body 606 may be confirmed if the fused score exceeds a fused threshold TF, i.e.:

S_{F}=T_{F}

The weighting term alpha a may be chosen to optimize performance. For example, and as noted above, it is preferable for FRR to be low. In other words, it may be preferable to have a low instance of application of the sensor 600 without detection of application. The weighting term alpha a may be selected to maximise performance for low FRR.

The above describe solution has several advantages such as but not limited to:
Cost Efficiency: Eliminating the need for additional hardware components for detecting application/insertion of the sensor 600, thereby reducing both material and testing costs.
Enhanced Accuracy: By fusing data from ISE and potentiostatic electrodes/cells, the chance of false alarms (FAR) is reduced, and false rejection rates (FRR) are optimized.
Flexibility: The system can adapt based on the characteristic behaviour of the sensors used, ensuring broader compatibility.

Thus, the described circuitry provides an innovative, cost-effective, and efficient solution for the detecting the application/insertion of wearable health sensors by leveraging combined feedback from ISE and enzymatic sensors. The dual-input methodology described above ensures high accuracy, reduced false alarms, and enhanced adaptability.

The described embodiments provide techniques for detecting the activation state of a device using combined sensor feedback from changes in impedance and voltage. Such solutions have applications beyond wearable sensors described above. Examples of potential use cases are provided below:
Environmental Sensors: These sensors can be embedded in the environment to detect changes, such as soil moisture content in agriculture. If a sensor is placed in the ground, the combined feedback could indicate whether it's correctly placed in moist soil or is still exposed.
Automotive Industry: In vehicles, similar sensors could ensure that parts or components are correctly installed. For instance, sensors on a tire could confirm if it has been securely fastened to the rim by measuring changes in electrical properties.
Home Appliances: For devices that require proper docking or insertion, such as a coffee machine's water reservoir, the combined feedback could determine if the reservoir is properly placed and filled with water.
Industrial Manufacturing: On production lines, combined sensor feedback could be used to confirm that parts are correctly inserted or fitted during assembly. This would be especially useful in quality control, ensuring that products are assembled correctly before shipping.
Electronics: In gadgets where batteries or memory cards need to be inserted, the technology could detect proper placement and contact. This could replace or supplement the mechanical detection systems currently in use.
Safety Equipment: In life vests, helmets, or other safety equipment where correct wear or activation is crucial, the sensor feedback can provide an immediate alert if the equipment isn't worn or activated properly.
Medical Devices: Besides wearable health sensors, other medical devices like catheters, implants, or diagnostic probes could utilize this feedback system to ensure correct positioning or functioning.
Research & Laboratories: In labs, when specific probes or equipment parts need to be inserted into solutions or other devices, the feedback mechanism can indicate a proper fit or immersion.
Consumer Goods: Products that require assembly or component insertion, like furniture or toys, could use this feedback system to guide users in correct assembly or indicate a successful connection.
Security Systems: In locks or access systems, the mechanism could serve as a redundant check, ensuring that a key, card, or other access device is correctly inserted.

Embodiments of the present disclosure may be implemented using one or more of the following circuit elements:
Differential Amplifier: To amplify the difference between the voltage signal from the ISE and the impedance change signal from the potentiostat electrode. A differential amplifier may have two inputs, one from the ISE and another from the potentiostat. The amplified difference provides a signal for detection and decision-making.
Multiplexer (MUX): To selectively switch between the outputs of the ISE and potentiostat for sequential processing. The multiplexer may be used to multiplex the sensor signals if the system comprises a single processing unit. The MUX may switch between the ISE and potentiostat signals based on a control signal, allowing sequential reading and analysis.
Analog-to-Digital Converter (ADC): To convert analog signals from the ISE and potentiostat into digital signals for digital processing or interfacing with microcontrollers. The ADC samples the continuous voltage and impedance signals and convert them into digital values for further processing.
Low-Pass Filter: To filter out high-frequency noise from the signal inputs, to aid in providing clearer signals for application/insertion detection. This may be implemented using a combination of resistors and capacitors to form an RC circuit that attenuates high-frequency components.
Comparator: To compare the combined signal (after fusion) with a predefined threshold. The comparator may take the fused signal SF as one input and the threshold ST as the second input. If the fused signal exceeds the threshold, the comparator output would indicate successful insertion.
Feedback Loop: To adjust and calibrate the threshold levels dynamically, improving accuracy of application/insertion detection over time and varying conditions. This circuit may analyse false positives and negatives, adjusting the threshold and amplification factors and/or weighting to optimize detection accuracy.
Power Management: To manage power consumption, ensuring the sensor 600 remains in a lower-power mode until insertion is detected. This circuitry may control power distribution to various components, only activating essential parts when needed, and ensuring power conservation when the device is not in use.
Digital Signal Processor (DSP) or Microcontroller Unit (MCU) Integration: To process digital signals, run fusion algorithms, and/or make a determination regarding application/insertion. The MCU or DSP may have built-in algorithms and decision-making logic. It may also facilitate communication with other devices or display units, providing feedback to the user.
Wireless Communication: To transmit insertion/application detection data and/or alerts wirelessly to external devices, host devices, or display units. This could involve implementing Bluetooth, Wi-Fi, or other wireless communication protocols to enable remote monitoring and feedback.
Haptic Feedback: To provide tactile feedback to the user upon successful application/insertion detection. Upon successful detection, circuitry could activate a small vibration motor to give tactile feedback to the user.

Depending on the final application, complexity, and power constraints, a combination of the above circuits could be implemented.

Embodiments are described above with reference to cells 100, 200, 400 comprising two or three electrodes. Embodiments of the disclosure are not, however, limited to having cells having only one counter electrode or only one working electrode. The concepts described herein are particularly applicable to cells comprising multiple working electrodes or multiple counter electrodes. In doing so, such sensors may either providing redundancy or enabling the sensing of multiple analytes in a single chip. This may be particularly advantageous in applications such as continuous glucose monitoring, where it may be desirable to measure concentrations of several analytes including but not limited to two or more of glucose, ketones, oxygen, lactate, and the like. Moreover, the measurement circuits described herein may be configurable in different configurations for different types of measurements. Such measurements may be of the same or different cells or electrodes.

Embodiments of the present disclosure are described with reference to example electrochemical cells 100, 200, 400. It will be appreciated, however, that the techniques and apparatus described herein may be used in conjunction with any conceivable electrochemical system, including but not limited to electrochemical cells comprising at least two electrodes (e.g. two or more of a counter electrode CE, a working electrode WE and a reference electrode RE), or electrochemical cells with more than three electrodes (e.g. two or more counter electrodes and/or two or more working electrodes). Electrodes of the electrochemical cells described herein may also be referred to as anodes and/or cathodes as is conventional in the field of electrical batteries.

The skilled person will recognise that some aspects of the above-described apparatus and methods may be embodied as processor control code, for example on a non-volatile carrier medium such as a disk, CD- or DVD-ROM, programmed memory such as read only memory (Firmware), or on a data carrier such as an optical or electrical signal carrier. For many applications embodiments of the invention will be implemented on a DSP (Digital Signal Processor), ASIC (Application Specific Integrated Circuit) or FPGA (Field Programmable Gate Array). Thus, the code may comprise conventional program code or microcode or, for example code for setting up or controlling an ASIC or FPGA. The code may also comprise code for dynamically configuring re-configurable apparatus such as re-programmable logic gate arrays. Similarly, the code may comprise code for a hardware description language such as Verilog™ or VHDL (Very high-speed integrated circuit Hardware Description Language). As the skilled person will appreciate, the code may be distributed between a plurality of coupled components in communication with one another. Where appropriate, the embodiments may also be implemented using code running on a field-(re)programmable analogue array or similar device in order to configure analogue hardware.

Note that as used herein the term module shall be used to refer to a functional unit or block which may be implemented at least partly by dedicated hardware components such as custom defined circuitry and/or at least partly be implemented by one or more software processors or appropriate code running on a suitable general-purpose processor or the like. A module may itself comprise other modules or functional units. A module may be provided by multiple components or sub-modules which need not be co-located and could be provided on different integrated circuits and/or running on different processors.

Embodiments may be implemented in a host device, especially a portable and/or battery powered host device such as a mobile computing device for example a laptop or tablet computer, a games console, a remote control device, a home automation controller or a domestic appliance including a domestic temperature or lighting control system, a toy, a machine such as a robot, an audio player, a video player, or a mobile telephone for example a smartphone.

As used herein, when two or more elements are referred to as “coupled” to one another, such term indicates that such two or more elements are in electronic communication or mechanical communication, as applicable, whether connected indirectly or directly, with or without intervening elements.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative. Accordingly, modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

Although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described above.

Unless otherwise specifically noted, articles depicted in the drawings are not necessarily drawn to scale.

All examples and conditional language recited herein are intended for pedagogical objects to aid the reader in understanding the disclosure and the concepts contributed by the inventor to furthering the art and are construed as being without limitation to such specifically recited examples and conditions. Although embodiments of the present disclosure have been described in detail, it should be understood that various changes, substitutions, and alterations could be made hereto without departing from the spirit and scope of the disclosure.

Although specific advantages have been enumerated above, various embodiments may include some, none, or all of the enumerated advantages. Additionally, other technical advantages may become readily apparent to one of ordinary skill in the art after review of the foregoing figures and description.

It should be noted that the above-mentioned embodiments illustrate rather than limit the invention, and that those skilled in the art will be able to design many alternative embodiments without departing from the scope of the appended claims. The word “comprising” does not exclude the presence of elements or steps other than those listed in a claim, “a” or “an” does not exclude a plurality, and a single feature or other unit may fulfil the functions of several units recited in the claims. Any reference numerals or labels in the claims shall not be construed so as to limit their scope.

1. Circuitry for detecting application of an electrochemical sensor to a subject, the electrochemical sensor comprising an ion-selective electrode and a first potentiostatic electrode, the circuitry comprising:
measurement circuitry configured to:
measure an ion-selective signal at the ion-selective electrode;
measure a potentiostatic signal at the first potentiostatic electrode;
processing circuitry configured to:
detect application of the electrochemical sensor to the subject based on the ion-selective signal and the potentiostatic signal.

2. Circuitry of claim 1, wherein the ion-selective signal comprises a voltage.

3. Circuitry of claim 1, wherein the potentiostatic signal comprises a current.

4. Circuitry of claim 1, wherein detecting application of the electrochemical sensor to the body comprises:
calculating a first score based on the ion-selective signal, the first score indicative of a proximity of the ion-selective signal to an expected ion-selective signal when the electrochemical sensor is applied to the body;
calculating a second score based on the potentiostatic signal, the second score indicative of a proximity of the potentiostatic signal to an expected potentiostatic signal when the electrochemical sensor is applied to the body; and
determining whether the electrochemical sensor is applied to the body based on the first and second scores.

5. Circuitry of claim 4, wherein determining whether the electrochemical sensor is applied to the body based on the first and second scores comprises:
comparing the first score to a first score threshold;
comparing the second score to a second score threshold; and
determining that the electrochemical sensor is applied to the body if the first and second scores exceed respective first and second thresholds.

6. Circuitry of claim 4, wherein the processing circuitry is configured to:
calculate the first score by comparing the ion-selective signal to a first distribution centred on the expected ion-selective signal; and
calculate the second score by comparing the potentiostatic signal to a second distribution c entered on the expected ion-selective signal.

7. Circuitry of claim 4, wherein determining whether the electrochemical sensor is applied to the subject based on the first and second scores comprises:
combining the first and second scores to obtain a combined score; and
comparing the combined score a combined score threshold; and
determining that the electrochemical sensor is applied to the subject if the combined score exceed the combined score threshold.

8. Circuitry of claim 7, wherein the first and second scores are weighted prior to the combining.

9. Circuitry of claim 8, wherein the first and second scores are weighted to maximise a false accept rate (FAR) and minimize a false reject rate (FRR) associated detecting application of the electrochemical sensor.

10. Circuitry of claim 7, wherein the combined score SF is calculated by the following equation:
$${S}_{F} = α {S}_{1} + ( 1 - α {S}_{2} )$$
where S₁ is the first score, S₂ is the second score, and a is a weighting factor between zero and one.

11. Circuitry of claim 1, wherein the measurement circuitry comprises a transimpedance amplifier or a current conveyor for measuring the potentiostatic signal.

12. Circuitry of claim 1, wherein the measurement circuitry comprises an analog-to-digital converter, ADC, configured to sample the potentiostatic signal.

13. Circuitry of claim 1, further comprising drive circuitry configured to apply a stimulus to a second potentiostatic electrode of the electrochemical sensor, the measured potentiostatic signal being a response to the stimulus.

14. Circuitry of claim 1, wherein the drive circuitry comprises a digital to analog converter, DAC.

15. Circuitry of claim 1, wherein the electrochemical sensor comprises a second potentiometric electrode, wherein the processing circuitry is configured to determine an impedance between the first and second potentiostatic electrodes.

16. Circuitry of claim 15, wherein the first potentiometric electrode comprises a working electrode and the second potentiometric electrode comprises a counter electrode.

17. Circuitry of claim 1, wherein the processing circuitry is configured to transition the wearable sensor from a low-power state to an active state upon detection of application of the wearable sensor to the subject.

18. Circuitry of claim 1, wherein the processing circuitry is configured to:
determine a concentration of an analyte in the electrochemical sensor based on the ion-selective electrode signal.

19. Circuitry of claim 18, wherein the analyte is sodium or potassium or magnesium.

20. Circuitry of claim 1, wherein the processing circuitry is configured to determine a concentration of an analyte in the electrochemical sensor based on the potentiostatic signal.

21. Circuitry of claim 20, wherein the analyte is glucose or ketones or lactates.

22. Circuitry of claim 1, wherein application of the electrochemical sensor to the subject comprises insertion of the ion-selective electrode and the first potentiostatic electrode through the skin of the subject.

23. An electrochemical sensor comprising:
a needle for insertion into a subject on application of the electrochemical sensor to the subject;
an ion-selective electrode;
a first potentiostatic electrode; and
circuitry of claim 1,
wherein the ion-selective electrode and the potentiostatic electrode are disposed on the needle.

24. A system comprising:
the wearable device; and
a host device comprising the circuitry of claim 1.

25.-26. (canceled)

27. An electronic device comprising the circuitry of claim 1, wherein the electronic device comprises one of a wearable device, an analyte monitoring device, an analyte sensing device, a battery, a battery monitoring device, a mobile computing device, a laptop computer, a tablet computer, a games console, a remote control device, a home automation controller or a domestic appliance, a toy, a robot, an audio player, a video player, or a mobile telephone, and a smartphone.

28. A method of detecting application of an electrochemical sensor to a subject, the electrochemical sensor comprising an ion-selective electrode and a first potentiostat electrode, the method comprising:
measuring an ion-selective signal at the ion-selective electrode;
measuring a potentiostatic signal at the first potentiostatic electrode;
detecting application of the electrochemical sensor to the subject based on the ion-selective signal and the potentiostatic signal.
